(19) United States
(12) Patent Application Publication
(10) Pub. No.: US 2018/0291659 A1
(43) Pub. Date: Oct. 11, 2018

(54) SLIDABLE LOCKING DEVICE

(71) Applicant: Spencer Burakowski, Los Angeles, CA (US)

(72) Inventor: Spencer Burakowski, Los Angeles, CA (US)

(21) Appl. No.: 15/485,032

(22) Filed: Apr. 11, 2017

(51) Int. Cl. E05D 11/10; E05D 5/00; E05D 7/14; E05D 7/10; E05B 65/00

(52) U.S. Cl. CPC E05D 11/1007; E05D 11/1014; E05D 5/00; E05Y 2900/21; E05D 7/1005; E05B 65/0075; E05D 7/14

(57) ABSTRACT

A slidable locking device is described that enables rotational movement like a hinge and also provides for selective locking. The slidable locking device may include a fixed hinge part, a rotatable hinge part, and a slidable hinge part. The fixed hinge part may include a first set of protrusions and openings. The slidable hinge part may also include a second corresponding set of protrusions and openings. The rotatable hinge part may also include a third corresponding set of protrusions and openings. The slidable hinge part may be slidably coupled to the fixed hinge part. The rotating hinge part may be rotatably coupled to the fixed hinge part. As the slidable hinge part moves longitudinally with respect to the fixed hinge part, the second set of protrusions and gaps alternatingly align with the first set of protrusions and gaps. This action may define a locked position and an unlocked position.

### BACKGROUND

Lockable cabinets such as safes typically include a body defining a compartment and a pivotable door that encloses the compartment. One side of the door may be attached to the body via a set of hinges. Other sides of the door (e.g., an opposite side) may include a locking mechanism designed to selectively secure the door to the body. The locking mechanism may include a combination of levers, dials, electronic interfaces, and the like to selectively secure the door to the body. For example, a rotating dial can be used to input a code to unlock the locking mechanism, and a lever can be used to disengage the locking mechanism from the body.

A safe may be rated by a manufacture or rating agency based on the degree of manipulation required to crack its locking mechanism(s) and open the safe. This degree of manipulation may be expressed in terms of duration of time to crack the safe (e.g., 15 minutes, 30 minutes, 60 minutes, etc.) and/or tools required (e.g., hand tools, gas torches, explosives, etc.). Thus, an increase in duration and/or a change in required tools, may increase the rating and usefulness of the safe.

### BRIEF DESCRIPTION OF THE DRAWINGS

The disclosure will be readily understood by the following detailed description in conjunction with the accompanying drawings, in which:

FIG. 1A shows a perspective view of an example slidable locking device in an unlocked state, in accordance with at least one example.

FIG. 1B shows a perspective view of an example slidable locking device in a locked state, in accordance with at least one example.

FIG. 2 shows various views of an example fixed hinge part of the slidable locking device of FIG. 1, in accordance with at least one example.

FIG. 3 shows various views of an example slidable hinge part of the slidable locking device of FIG. 1, in accordance with at least one example.

FIG. 4 shows various views of an example rotatable hinge part of the slidable locking device of FIG. 1, in accordance with at least one example.

FIG. 5A shows a perspective view of an example lockable cabinet including an example slidable locking device, in accordance with at least one example.

FIG. 5B shows a view of an inside view of the lockable cabinet of FIG. 5A, in accordance with at least one example.

FIG. 6 shows a top perspective view of an example lockable cabinet including an example slidable locking device, in accordance with at least one example.

FIG. 7A shows a zoomed-in view of the slidable locking device shown in FIG. 6 in an unlocked state, in accordance with at least one example.

FIG. 7B shows a zoomed-in view of the slidable locking device shown in FIG. 6 in a locked state, in accordance with at least one example.

FIG. 8A shows a top view of the slidable locking device shown in FIG. 6 in a first state, in accordance with at least one example.

FIG. 8B shows a top view of the slidable locking device shown in FIG. 6 in a second state, in accordance with at least one example.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described examples as defined by the appended claims.

Examples of the present disclosure are directed to a device. In particular, examples are directed to a slidable locking device adapted to function as a lockable hinge. The slidable locking device can be installed in place of or in addition to a conventional hinge in a safe or other lockable cabinet. In this manner, the slidable locking device may be used to attach a door to a body of the safe. The slidable locking device may be configurable between a locked and an unlocked state. For example, a lever and/or actuator or other motive element may be coupled to the slidable locking device to configure the device between the two states. In the locked state, the slidable locking device may function to obstruct rotation of the door. In the unlocked state, the slidable locking device may not obstruct rotation of the door (e.g., function as a hinge). The slidable locking device may be installed in the safe as the exclusive means for locking the safe. In some examples, the safe also includes a traditional locking mechanism that, in conjunction with the slidable locking device, functions to secure the safe. The slidable locking device may provide an additional layer of security for securing conventional safes or other lockable cabinets. To break this additional layer of security may require additional time and/or different tools as compared to safes not including the slidable locking device. In this manner, use of the slidable locking device may provide for a more effective safe.

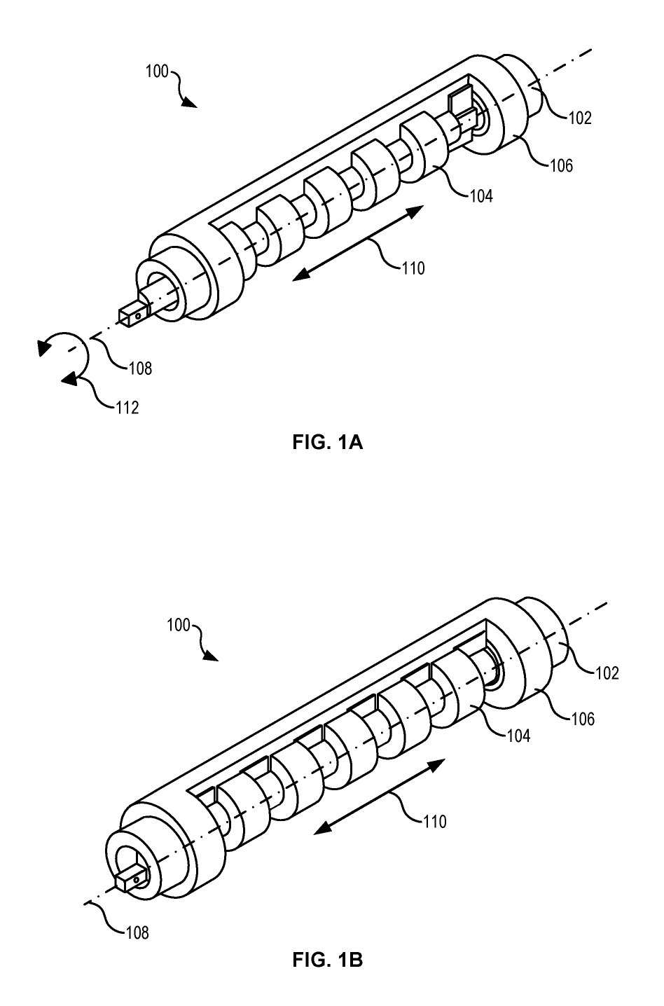

Turning now to the Figures, FIG. 1A illustrates a slidable locking device 100 including a fixed hinge part 102, a slidable hinge part 104, and a rotatable hinge part 106, each coaxially aligned with an alignment axis 108 or other longitudinal axis. As described herein, the fixed hinge part 102 and the slidable hinge part 104 may be coupled together via a structure that enables longitudinal movement (e.g., via a tongue and groove). In this manner, the slidable hinge part 104 may be capable of translating longitudinally with respect to the alignment axis 108 (e.g., in the directions of arrow 110). When the slidable locking device 100 is included in a lockable safe, the fixed hinge part 102 may be coupled to a wall of the lockable safe or a door of the lockable safe and the rotatable hinge part 106 may be coupled to the door of the lockable safe or the wall of the lockable safe. The rotatable hinge part 106 may be configured to rotate about the alignment axis 108 (e.g., in the direction of arrow 112). This rotation may depend, at least in part, on a position of the slidable hinge part 104 with respect to the fixed hinge part 102 and the rotatable hinge part 106.

For example, in FIG. 1A, the slidable hinge part 104 is shown in a first position with respect to the other hinge parts 102, 106. This first position may correspond to an unlocked state of the slidable locking device 100. The state may be considered unlocked because rotation of the rotatable hinge part 106 about the alignment axis 108 may be unimpeded by the slidable hinge part 104. In other words, a first grooved pattern including structures of alternating elevation of the slidable hinge part 104 is aligned with a second, similar grooved pattern of the fixed hinge part 102. Thus, a third, similar grooved pattern of the rotatable hinge part 106 indexes within the first and second grooved patterns. Continuing with the lockable safe example from above, in the unlocked state, the slidable locking device 100 may not interfere with the opening and closing of the door.

In FIG. 1B, the slidable hinge part 104 is shown in a second position with respect to the other hinge parts 102, 106. This position may correspond to a locked state of the slidable locking device 100. The state may be considered locked because rotation of rotatable hinge part 106 may be impeded by the slidable hinge part 104. In other words, the first grooved pattern including structures of alternating elevation of the slidable hinge part 104 is misaligned with the second, similar grooved pattern of the fixed hinge part 102. This misalignment is a result of the slidable hinge part 104 translating along the alignment axis 108. Thus, the elevated structures of the third, similar grooved pattern of the rotatable hinge part 106 contact similar elevated structures of the slidable hinge part 104. Continuing with the lockable safe example from above, in the locked state, the slidable locking device 100 may interfere with the operation of the door by preventing the door from opening and/or closing.

Parts of the slidable locking device 100 may be formed from any suitable material including, for example, metal, high-density plastics, wood, composite materials, and any other material having suitable strength characteristics. Parts of the slidable locking device 100 may be formed in any suitable manner, which may depend on the material selected for forming. For example, parts of the slidable locking device 100 may be molded, machined, stamped, or formed using any other suitable manufacturing technique.

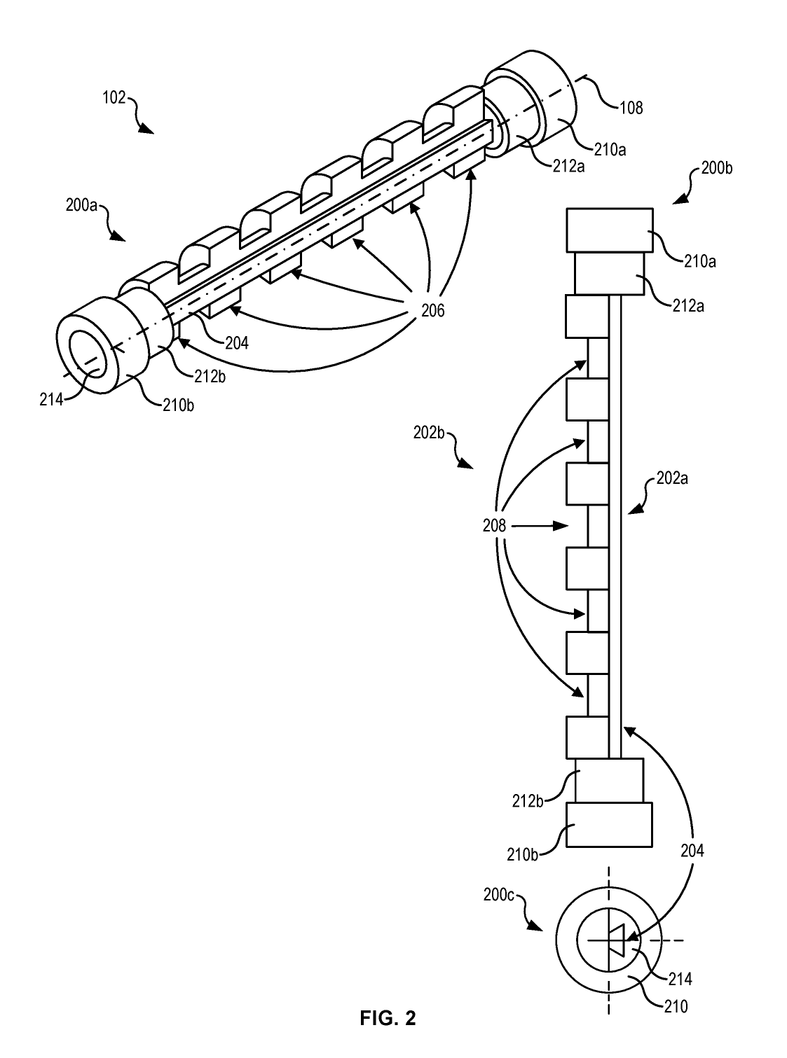

FIG. 2 illustrates various views 200a-200c of the fixed hinge part 102 of the slidable locking device 100, in accordance with at least one example. The view 200a is a perspective view. The view 200b is a side view. The view 200c is an end view. The fixed hinge part 102 may be defined as having a first side 202a and a second side 202b. The first side 202a may include a first portion of a coupling structure such as a tongue 204. The tongue 204 may extend in the direction of the alignment axis 108 and may mate with a corresponding coupling structure of the slidable hinge part 104 (e.g., a groove). This coupling may enable the slidable hinge part 104 to translate with respect to the fixed hinge part 102 (e.g., along the alignment axis 108). Other coupling structures that enable translation may also be used.

The second side 202b may include a set of partial cylinders 206 that extend radially from the alignment axis 108 (or other longitudinal axis) and is spaced apart so as to define a set of gaps 208 or recessed portions. The set of partial cylinders 206 may be defined as a set of half cylinders aligned with the alignment axis 108. In some examples, diameters of individual ones of the set of partial cylinders 206 may be equal or about equal. In other examples, the diameters may be various. In some examples, the diameters of individual ones of first set of partial cylinders 206 may be continuous or may be various. For example, for a particular partial cylinder 206, a first diameter measured at a first position may have a first value and a second diameter measured at a second position may have a second value. The set of gaps 208 may be defined as areas between the set of partial cylinders 206 that have diameters smaller than the set of partial cylinders 206. In some examples, walls of the set of partial cylinders 206 may be perpendicular with respect to the alignment axis 108 (e.g., U shaped or mostly U shaped) or may be sloped (e.g., V shaped or mostly V shaped). The set of partial cylinders 206 and the set of gaps 208 may together define a pattern. For example, as illustrated in the view 200b, the pattern may correspond to a repeating pattern of mountains (e.g., partial cylinders 206) and valleys (e.g., gaps 208). In some examples, fewer or more partial cylinders 206 and gaps 208 may make up the pattern.

The fixed hinge part 102 may also include attachment structure 210 and rotation structure 212 disposed at both ends of the fixed hinge part 102. In some examples, the fixed hinge part 102 may include a single attachment structure 210 and a single rotation structure 212 located at the same or opposite ends of the fixed hinge part 102. The attachment structures 210 may be configured for mounting the slidable locking device 100 to an external bracket to enable attachment to a fixed structure such as a body of a safe. For example, the attachment structures 210 may be welded, fused, bolted, glued, or otherwise attached to the external bracket. In some examples, the attachment structure 210 may include a set of cylindrical structures 210a, 210b.

The rotation structures 212 may be configured to receive corresponding rotation structures of the rotatable hinge part 106. For example, the rotation structures 212 may include a set of cylindrical structures 212a, 212b over which a set of corresponding rotation structures of the rotatable hinge part 106 may be indexed. In this manner, the rotation structures 212 may function as a rotational interface between the fixed hinge part 102 and the rotatable hinge part 106. In some examples, the rotation structures 212 may include a set of bearings to reduce friction between the fixed hinge part 102 and the rotatable hinge part 106 at the rotational interfaces. The attachment structures 210 and/or the rotation structures 212 may be removable from the remaining portion of the fixed hinge part 102. This may enable the slidable hinge part 104 to be mounted to the fixed hinge part 102. At least one end of the slidable hinge part 104 may extend via an opening 214 of the fixed hinge part 102. The opening 214 may extend through the cylindrical structure 210b and the cylindrical structure 212b.

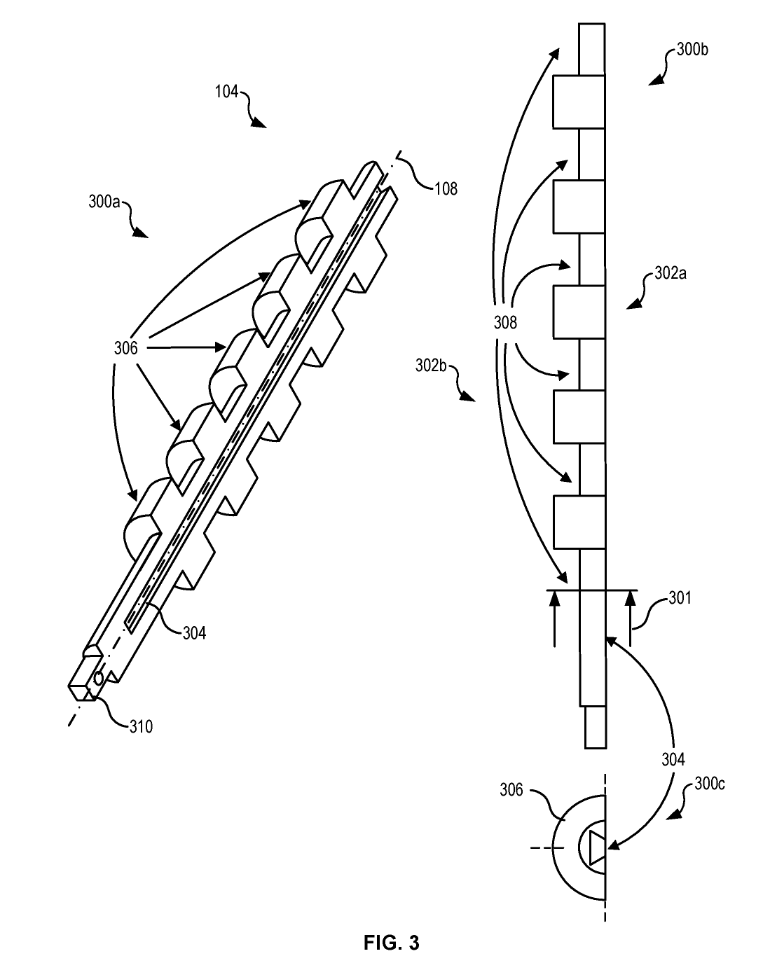

FIG. 3 illustrates various views 300a-300c of the slidable hinge part 104 of the slidable locking device 100, in accordance with at least one example. The view 300a is a perspective view. The view 300b is a side view. The view 300c is a profile view taken at 301 of the slidable hinge part 104. The slidable hinge part 104 may be defined as having a first side 302a and a second side 302b. The first side 302a may include a first portion of a coupling structure such as a groove 304. The groove 304 may extend in the direction of the alignment axis 108 and may mate with a corresponding coupling structure of the fixed hinge part 102 (e.g., the tongue 204). This coupling may enable the slidable hinge part 104 to translate with respect to the fixed hinge part 102 (e.g., along the alignment axis 108). Other coupling structures that enable translation may also be used (e.g., slider and rail, etc.).

The second side 302b may include a set of partial cylinders 306 that extend radially from the alignment axis 108 (or other longitudinal axis) and is spaced apart so as to define a set of gaps 308 or recessed portions. The set of partial cylinders 306 may be defined as a set of half cylinders aligned with the alignment axis 108. In some examples, diameters of individual ones of the set of partial cylinders 306 may be equal or about equal. In other examples, the diameters may be various. In some examples, the diameters of individual ones of the set of partial cylinders 306 may be continuous or may be various. For example, for a particular partial cylinder 306, a first diameter measured at a first position may have a first value and a second diameter measured at a second position may have a second value. The set of gaps 308 may be defined as areas between the set of partial cylinders 306 that have diameters smaller than the set of partial cylinders 306. In some examples, walls of the set of partial cylinders 306 may be perpendicular with respect to the alignment axis 108 (e.g., U shaped or mostly U shaped) or may be sloped (e.g., V shaped or mostly V shaped). The set of partial cylinders 306 and the set of gaps 308 may together define a pattern. For example, as illustrated in the view 300b, the pattern may correspond to a repeating pattern of mountains (e.g., partial cylinders 306) and valleys (e.g., gaps 308). The pattern may correspond in size and shape to the pattern of the fixed hinge part 102 and the rotatable hinge part 106. In some examples, fewer or more partial cylinders 306 and gaps 308 make up the pattern.

The slidable hinge part 104 may also include an attachment location 310. The attachment location 310 may be used to attach the slidable hinge part 104 to an actuator, lever, or other structure to control the movement of the slidable hinge part 104 when coupled to the fixed hinge part 102.

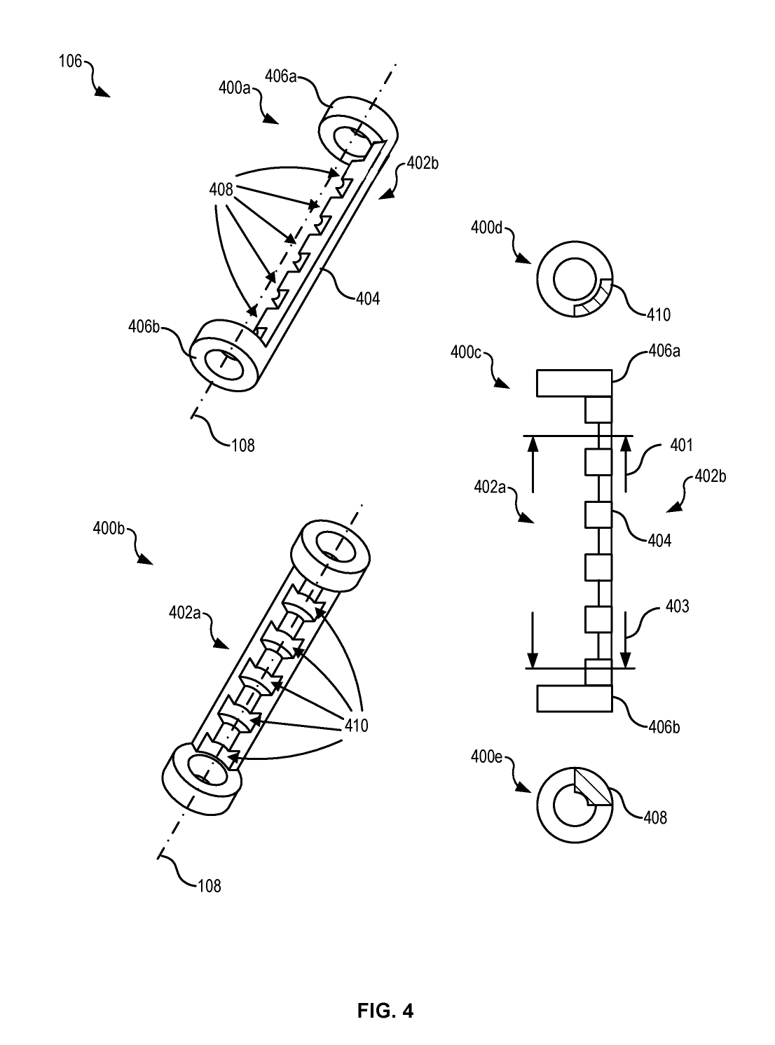

FIG. 4 illustrates various views 400a-400e of the rotatable hinge part 106 of the slidable locking device 100, in accordance with at least one example. The view 400a is a first perspective view of a first side 402a. The view 400b is a second perspective side view of a second side 402b. The view 400c is a side view. The view 400d is a first profile view taken at 401. The view 400d is a second profile view taken at 403. The rotatable hinge part 106 may be defined as having the first side 402a and the second side 402b, which may be a first side and a second side of an arcuate section 404 of the rotatable hinge part 106. The arcuate section 404 may be an arcuate section that extends longitudinally and is spaced radially from the alignment axis 108 (or other longitudinal axis). The body 404 may be disposed between two mounting structures 406a, 406b. The mounting structures 406, which may have any suitable cylindrical structure (e.g., ring, annular, etc.) may function as points of rotation for the slidable locking device 100. For example, the mounting structures 406 may be configured to receive the rotation structures 212 of the fixed hinge part 102 within openings of the mounting structures 406. Additionally, exterior surfaces of the mounting structures 406 may be coupled to one or more brackets in order to attach the rotatable hinge part 106 to a door of a lockable safe or to a body of the lockable safe.

On the first side 402a of the arcuate section 404 may be disposed a set of partial cylinders 408 that extend toward the alignment axis 108 (or other longitudinal axis) from the arcuate section 404. The set of partial cylinders 408 may be spaced so as to define a set of gaps 410 or recessed portions. The set of partial cylinders 408 and the set of gaps 410 may be formed in the arcuate section 404. In some examples, the set of partial cylinders 408 may be sized (e.g., length, width, height, shape, radius of curvature, etc.) to correspond to the set of gaps 208 and the set of gaps 308. Similarly, the set of gaps 410 may be sized (e.g., length, width, height, shape, radius of curvature, etc.) to correspond to the set of partial cylinders 206 and the set of partial cylinders 306. In this manner, the set of partial cylinders 408 and the set of gaps 410 may index with the sets of gaps 208, 308 and the sets of partial cylinders 206, 306.

In some examples, diameters of individual ones of the set of partial cylinders 408 may be equal or about equal. In other examples, the diameters may be various. In some examples, the diameters of individual ones of the set of partial cylinders 408 may be continuous or may be various (e.g., cam shaped). For example, for a particular partial cylinder 408, a first diameter measured at a first position may have a first value and a second diameter measured at a second position may have a second value. The set of gaps 410 may be defined as areas between the set of partial cylinders 408 that have radial widths that are less than radial widths of the set of partial cylinders 408. In some examples, walls of the set of partial cylinders 408 may be perpendicular with respect to the alignment axis 108 (e.g., U shaped or mostly U shaped) or may be sloped (e.g., V shaped or mostly V shaped). The set of partial cylinders 408 and the set of gaps 410 may together define a pattern. For example, as illustrated in the view 400c, the pattern may correspond to a repeating pattern of mountains (e.g., the partial cylinders 408) and valleys (e.g., the gaps 410). The pattern may correspond in size and shape to the pattern of the fixed hinge part 102 and the slidable hinge part 104. In some examples, fewer or more partial cylinders 408 and gaps 410 may make up the pattern.

As introduced above, the view 400d corresponds to a first profile view taken at 401. The view 400d illustrates one of the gaps 410. The view 400e corresponds to a second profile view taken at 403. The view 400e illustrates one of the partial cylinders 408.

Returning to FIGS. 1A and 1B, the slidable hinge part 104 may be moveable along the alignment axis 108 (or other longitudinal axis) between the first position (e.g., the unlocked state illustrated in FIG. 1A) and the second position (e.g., the locked state in FIG. 2A). In the first position, the set of partial cylinders 206 is aligned with the set of partial cylinders 306 and the set of gaps 208 is aligned with the set of gaps 308. This alignment enables the rotating hinge part 106 to freely rotate about the alignment axis 108 such that the set of partial cylinders 408 alternatingly extend into the set of gaps 208, 308 and the set of partial cylinders 206, 306 alternatingly extend into the set of gaps 410. In the second position, when the set of partial cylinders 408 is removed from the set of gaps 308, the set of partial cylinders 306 is aligned with the set of partial cylinders 408 and the set of gaps 306 is aligned with the set of gaps 410 so as to impede rotation of the rotatable hinge part 106 about the alignment axis 108 and over the slidable hinge part 104.

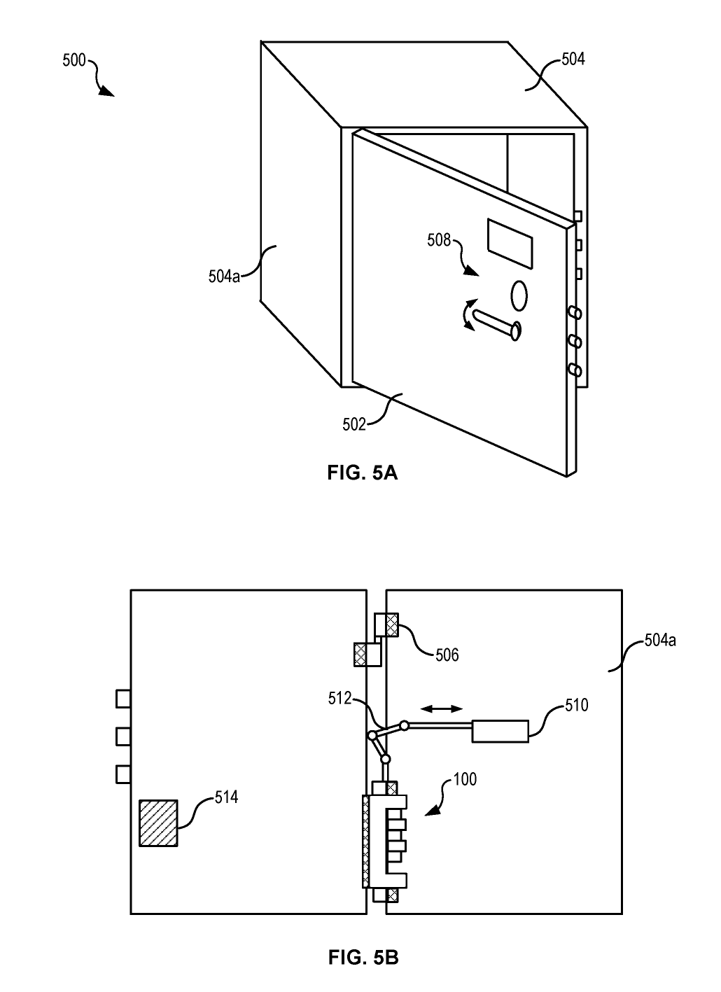

FIGS. 5A and 5B respectively illustrate a perspective view and an inside view of an example lockable cabinet 500 including the slidable locking device 100, in accordance with various examples. The lockable cabinet 500 may be any suitable cabinet, box, safe, or other structure that may be lockable (e.g., gates, doors, etc.). The lockable cabinet 500 may include a door 502 and a body 504. The slidable locking device 100 may be installed to attach the door 502 to body part 504a (e.g., wall) of the lockable cabinet 500. The door 502 may also be attached to the body part 504a via one or more other hinges 506. As the slidable locking device 100 functions as a hinge, the other hinges 506 may not be required, in some examples. The lockable cabinet 500 may also include a locking mechanism 508. The locking mechanism 508 may include any suitable component conventionally used to secure a lockable structure. Such components include, for example, levers, knobs, dials, handles, electronic controls, electronic interfaces, biometric interfaces, displays, keypads, deadbolts, padlocks, knob locks, magnetic keyed interfaces, tumblers, and any other suitable component which may be used to secure a lockable structure. As the slidable locking device 100 may function to secure the lockable cabinet 500, the locking mechanism 508 may not be required, in some examples. In the example illustrated, the slidable locking device 100 may be used in connection with the locking mechanism 508 to provide an additional layer of security for the lockable cabinet 500.

The slidable locking device 100 may be coupled to an actuator 510 via a drive rod 512 or other coupling. The actuator 510 may be any suitable actuator including, for example, hydraulic, pneumatic, electric, and/or mechanical. The actuator 510 may have a linear design or any other suitable design. In some examples, the force for sliding the slidable hinge part 104 may be applied by a different motive element such as a spring, compressed gas, or other motive element. The actuator 510 may be attached to the body part 504a and may be configured to move the slidable hinge part 104 from the unlocked position to the locked position and vice versa. In some examples, the slidable hinge part 104 is manually actuated via a lever or other structure available at the exterior of the lockable cabinet 500. When the lockable cabinet 500 is unlocked, as shown in the illustration, the slidable locking device 100 is in the unlocked state. This allows the door 502 to be open and closed without any additional resistance. In some examples, the slidable locking device 100 can be unlocked simultaneously with the unlocking of the locking mechanism 508. For example, after a correct code has been entered at an electronic interface, an electronic controller may send a signal to the actuator 510 to unlock the slidable locking device 100. This controller may also send a signal to a component of the locking mechanism 508 to unlock. In some examples, unlocking/locking of the slidable locking device 100 may be independent of the unlocking/locking of the locking mechanism 508. For example, after the locking mechanism 508 has been unlocked, a separate action may be used to unlock the slidable locking device 100. This action may include use of a proximity-based technology (e.g., keycard, smart card, radio-frequency identification (RFID) cards, near-field communication (NFC) devices, and any other suitable device that relies on proximity-based technologies). In some examples, this action may include a user sending a request to a locking service (e.g., a network computer separate from the lockable cabinet 500) to unlock the lockable cabinet 500. The request may originate at a user device (e.g., mobile phone, watch, laptop, etc.) of the user. If the request is proper (e.g., the user device and/or identity can be authenticated, the location of the user device is within some threshold distance of the lockable cabinet, and/or any other suitable authentication technique), the locking service may send an unlock signal to a local computing device, which in turn may cause the lockable cabinet 500 to unlock (e.g., unlock the slidable locking device 100).

In the illustrated example, the lockable cabinet may be unlocked and locked by interacting with an RFID scanner 514. When the correct frequency is received by the RFID scanner 514, the actuator 510 is activated which uses the drive rod 512 to move the slidable locking device 100 from the locked state to the unlocked state or vice versa. In some examples, the RFID scanner 514 may be mounted on an interior of the lockable cabinet 500 (e.g., on an inside surface of the body part 504a or on the door 502), on an exterior of the lockable cabinet 500 (e.g., on an exterior surface of the door 502), or at any other suitable location, which may be separate from the lockable cabinet 500.

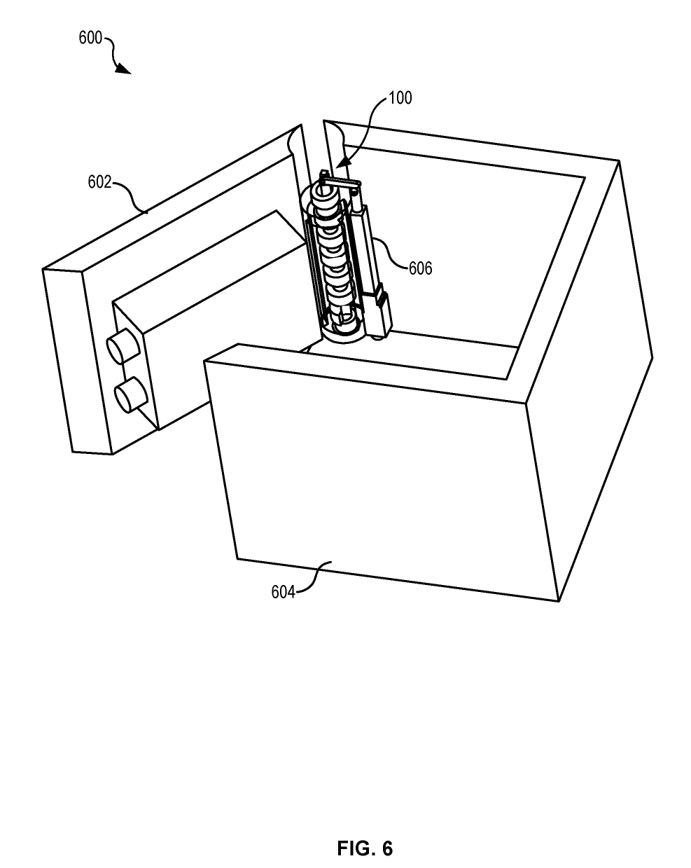

FIG. 6 shows a top perspective view of an example lockable cabinet 600 including the slidable locking device 100, in accordance with at least one example. The lockable cabinet 600 is an example of the lockable cabinet 500, and may therefore include a door 602 and a body 604. In the view illustrated in FIG. 6, a top side of the lockable cabinet 600 is removed. The slidable locking device 100 may be installed to attach the door 602 to the body 604. In this manner, the slidable locking device 100 may function as a hinge and a lock for the lockable cabinet 600. The slidable locking device 100 is illustrated in FIG. 6 with the rotatable hinge part 106 being transparent. This is done to better illustrate the operation of the other components of the slidable locking device 100. The slidable locking device 100 may be locked and unlocked by an actuator 606. In this example, the actuator 606 is aligned with the slidable locking device 100.

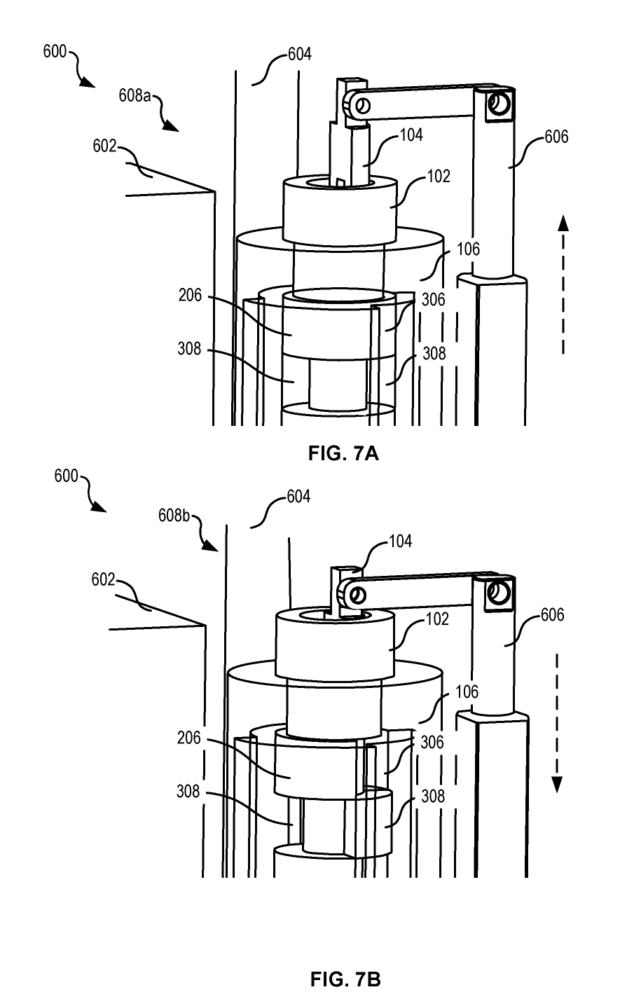

FIGS. 7A and 7B show zoomed-in perspective views 608a, 608b of the lockable cabinet 600 including the slidable locking device 100, respectively, in an unlocked state and a locked state, in accordance with various examples.

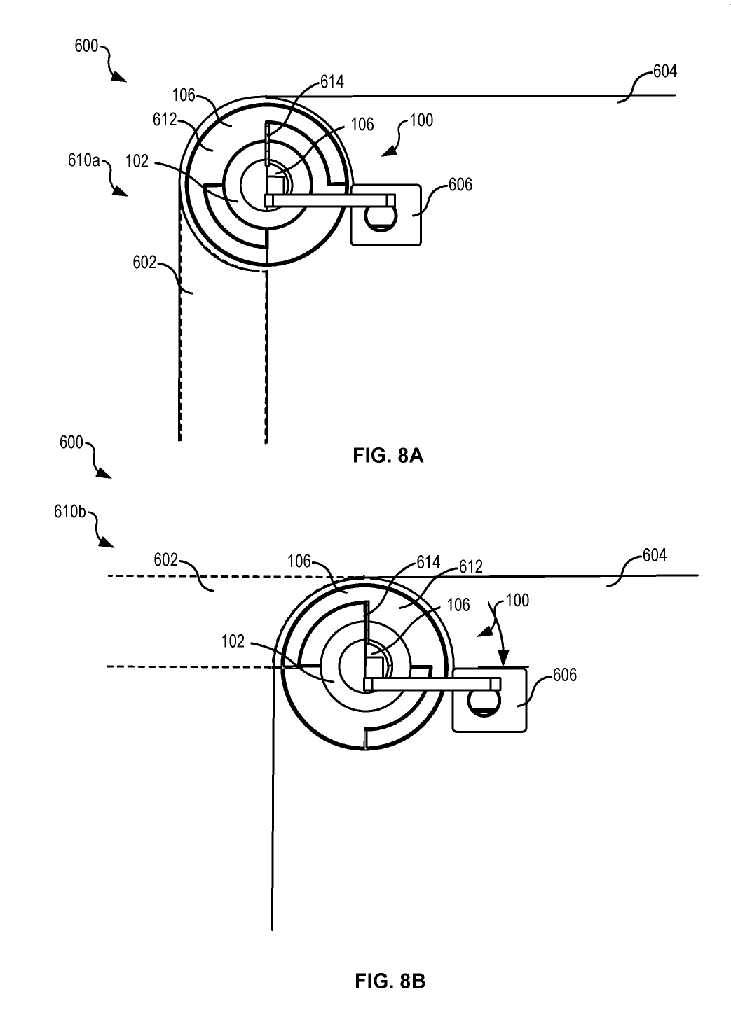

FIGS. 8A and 8B show top views 610a, 610b of the lockable cabinet 600 including the slidable locking device 100, respectively in a first state and a second state, in accordance with various examples. The slidable locking device 100 is illustrated in FIGS. 7 and 8 with the rotatable hinge part 106 being transparent. This is done to better illustrate the operation of the other components of the slidable locking device 100.

In the view 608a, the actuator 606 is illustrated in an extended position (e.g., a higher elevation), which has caused the slidable hinge part 104 to be similarly extended out of the opening of the fixed hinge part 102. This may define an unlocked state because the sets of partial cylinders 206, 306 and the set of gaps 208, 308 are aligned with each other. In the view 608b, the actuator 606 is illustrated in a contracted position (e.g., at a lower elevation), which has caused the slidable hinge part 104 to return back within the opening of the fixed hinge part 102. This may define a locked state because the sets of partial cylinders 206, 306 and the sets of gaps 208, 308 are no longer aligned with each other. Thus, the slidable locking device 100 has effectively stopped operating as a hinge because the rotatable hinge part 106 (e.g., the partial cylinders 408) will collide with the partial cylinders 306d.

In the view 610a, the door 602 is illustrated in a closed state. In the view 610b, the door 602 is illustrated in an open state. In the closed state, a solid quadrant 612 of the rotatable hinge part 106 is shown in a first position. The solid quadrant 612 may correspond to one of the partial cylinders 408. When the slidable locking device 100 is also locked in the closed state, the solid quadrant 612 abuts against the slidable hinge part 104 at location 614, which keeps the rotatable hinge part 106 from rotating. In the open state illustrated in the view 610b, the solid quadrant 612 is shown in a second position. The solid quadrant 612 has been rotated about 90 degrees clockwise from the first position to the second position. When the slidable locking device 100 is also unlocked in the open state, the solid quadrant is able to pass by the slidable hinge part 104 at the location 614. This enables the rotation of the door 602 and the rotatable hinge part 106.

Spatially relative terms, such as “below,” “above,” “lower,” “upper,” and the like may be used above to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context. The above description of examples of the disclosure has been presented for the purposes of illustration and description. It is not intended to be exhaustive or to limit the disclosure to the precise form described, and many modifications and variations are possible in light of the teaching above. The examples were chosen and described in order to best explain the principles of the disclosure and its practical applications to thereby enable others skilled in the art to best utilize the claimed subject matter in various examples and with various modifications as are suited to the particular use contemplated. Thus, it will be appreciated that the disclosure is intended to cover all modifications and equivalents within the scope of the following claims

All references, including publications, patent applications, and patents, cited herein are hereby incorporated by reference to the same extent as if each reference were individually and specifically indicated to be incorporated by reference and were set forth in its entirety herein.

What is claimed is:

1. A device, comprising:
a first hinge part comprising:
a first longitudinal axis;
a first set of partial cylinders extending radially from the first longitudinal axis and spaced so as to define a first set of gaps, the first set of partial cylinders and the first set of gaps disposed on a first side of the first hinge part; and
a groove extending longitudinally along a portion of a second side of the first hinge part;
a second hinge part slidably coupled to the first hinge part, and comprising:
a second longitudinal axis;
a second set of partial cylinders extending radially from the second longitudinal axis and spaced so as to define a second set of gaps, the second set of partial cylinders and the second set of gaps disposed on a first side of the second hinge part; and
a tongue extending longitudinally along a portion of a second side of the second hinge part, the tongue dimensioned to be received into the groove to enable slidable movement of the second hinge part with respect to the first hinge part; and
a third hinge part rotatably coupled to the first hinge part, and comprising:
a third longitudinal axis;
an arcuate section extending longitudinally and spaced radially from the third longitudinal axis; and
a third set of partial cylinders extending toward the third longitudinal axis from the arcuate section and spaced so as to define a third set of gaps, the third hinge part configured to receive the first hinge part so that the third set of partial cylinders extend into the first set of gaps and the first set of partial cylinders extend into the third set of gaps,
wherein the second hinge part is slidable along the second longitudinal axis between:
a first position where the second set of partial cylinders is aligned with the first set of partial cylinders and the second set of gaps is aligned with the first set of gaps so as to enable rotation of the third hinge part about the third longitudinal axis such that the third set of partial cylinders is selectively extendable past the first set of gaps and the second set of gaps; and
a second position where, when the third set of partial cylinders is removed from the second set of gaps, the second set of partial cylinders is aligned with the third set of partial cylinders and the second set of gaps is aligned with the third set of gaps so as to impede rotation of the third hinge part about the third longitudinal axis and over the second hinge part.

2. The device of claim 1, wherein the first set of partial cylinders is a first set of half cylinders, the second set of partial cylinders is a second set of half cylinders, and the third set of cylinders is a first set of quarter cylinders.

3. The device of claim 1, wherein the second hinge part comprises a coupling structure configured to couple the second hinge part with a motive element that moves the second hinge part between the first position to the second position.

4. The device of claim 1, wherein, when the second hinge part is slid to the first position defining an unlocked state for the device, first faces of the first set of partial cylinders are aligned with second faces of the second set of partial cylinders so as to define a set of uniform cylindrical structures extending radially from the first longitudinal axis and the second longitudinal axis.

5. The device of claim 1, wherein, when the second hinge part is slid to the second position defining a locked state for the device, first faces of the second set of partial cylinders are aligned with second faces of the third set of partial cylinders such that contact between the first faces and the second faces impede the rotation of the third hinge part about the third longitudinal axis over the second hinge part.

6. The device of claim 1, wherein the third hinge part comprises a set of cylindrical rings disposed at opposite ends of the third hinge part and configured to receive ends of the first hinge part.

7. The device of claim 1, wherein:
the first hinge part is configured for mounting to an enclosure of a lockable cabinet; and
the third hinge part is configured for mounting to a pivotable door of the lockable cabinet.

8. A device, comprising:
a fixed hinge part comprising:
a first longitudinal axis;
a first protrusion extending radially from the first longitudinal axis and spaced along the fixed hinge part so as to define a first opening adjacent to the first protrusion;
a slidable hinge part slidably coupled to the fixed hinge part, and comprising:
a second longitudinal axis;
a second protrusion extending radially from the second longitudinal axis and spaced along the slidable hinge part so as to define a second opening adjacent to the second protrusion;
a rotatable hinge part rotatably coupled to the fixed hinge part, and comprising:
a third longitudinal axis; and
a third protrusion mounted on the rotatable hinge part and spaced from the third longitudinal axis so as to define a third opening adjacent to the third protrusion, the rotatable hinge part configured to receive the fixed hinge part so that the third protrusion extends into the first opening and the first protrusion extends into the third opening;
wherein the slidable hinge part is slidable along the second longitudinal axis between:
a first position where the second protrusion is aligned with the first protrusion and the second opening is aligned with the first opening to as to enable rotation of the rotatable hinge part about the third longitudinal axis such that the third protrusion is selectively extendable past the first protrusion and the second protrusion; and
a second position where, when the third protrusion is removed from the second opening, the second protrusion is aligned with the third protrusion and the second opening is aligned with the third opening so as to impede rotation of the third hinge part about the third longitudinal axis and over the second hinge part.

9. The device of claim 8, wherein:
the fixed hinge part comprises a tongue that extends longitudinally with respect to the first longitudinal axis; and
the slidable hinge part comprises a groove that extends longitudinally with respect to the second longitudinal axis, the groove configured to receive the tongue to enable slidable movement of the slidable hinge part with respect to the fixed hinge part.

10. The device of claim 8, wherein the rotatable hinge part comprises an arcuate section extending longitudinally and spaced radially from the third longitudinal axis, the third protrusion extending from the arcuate section toward the third longitudinal axis.

11. The device of claim 8, wherein the first protrusion comprises a first half cylinder, the second protrusion comprises a second half cylinder, and the third protrusion comprises a partial cylinder that is less than half of a full cylinder.

12. The device of claim 8, wherein the slidable hinge part comprises a coupling structure configured to couple the slidable hinge part with a motive element that moves the slidable hinge part from the first position to the second position.

13. The device of claim 8, wherein, when the slidable hinge part is slid to the first position defining an unlocked state for the device, a first face of the first protrusion is aligned with a second face of the second protrusion so as to define a uniform cylindrical structure extending radially from the first longitudinal axis and the second longitudinal axis.

14. The device of claim 8, wherein the rotatable hinge part comprises a set of cylindrical rings disposed at opposite ends of the rotatable hinge part and configured to receive ends of the fixed hinge part.

15. A lockable cabinet, comprising:
an enclosure comprising an opening;
a door selectively closeable over the opening;
a first hinge part comprising:
a fixed part attached to the enclosure adjacent to the opening or to the door; and
a slidable part slidably coupled to the fixed part; and
a second hinge part rotatably coupled to the first hinge part and attached to the door or the enclosure,
wherein the slidable part is slidable along a longitudinal axis between:
a first position where the slidable part is aligned with the fixed part so as to define a rotational pathway for the second hinge part to rotate about the longitudinal axis over the fixed part and the slidable part; and
a second position where the slidable part is misaligned with the fixed part so as to impede rotation of the second hinge part about the longitudinal axis over the slidable part.

16. The lockable cabinet of claim 15, further comprising a motive element coupled to the slidable hinge part and configured to move the slidable part between the first position and the second position.

17. The lockable cabinet of claim 16, wherein:
the motive element comprises an actuator; and
the lockable cabinet further comprises a control module in electrical communication with the actuator and configured to control the operation of the actuator in response to a control signal.

18. The lockable cabinet of claim 15, wherein:
the fixed part comprises a first protrusion extending radially from the longitudinal axis and spaced along the fixed part so as to define a first opening adjacent to the first opening;
the slidable part comprises a second protrusion extending radially from the longitudinal axis and spaced along the slidable part so as to define a second opening adjacent to the second protrusion;
the second hinge part comprises a third protrusion mounted on the second hinge part and spaced from the longitudinal axis so as to define a third opening adjacent to the third protrusion, the second hinge part configured to receive the fixed part so that the third protrusion extends into the first opening and the first protrusion extends into the third opening.

19. The lockable cabinet of claim 15, further comprising:
a lever coupled to the slidable part and configured to move the slidable part between the first position and the second position; and
a locking mechanism coupled to the lever and configured to:
allow movement of the slidable part when in an unlocked state; and
impede the movement of the slidable part when in a locked state.

20. The lockable cabinet of claim 19, wherein the locking mechanism is further configured to selectively secure the door to the enclosure.
